(19) United States
(12) Patent Application Publication
(10) Pub. No.: US 2024/0190550 A1
(43) Pub. Date: Jun. 13, 2024

(54) HYBRID PROPULSION SYSTEM

(71) Applicant: Duxion Motors, Inc., St. Johns's (CA)

(72) Inventors: Rick Ralph Pilgrim, Grand Falls-Windsor (CA); Richard Robert Roper, Katy, TX (US)

(21) Appl. No.: 18/532,779

(22) Filed: Dec. 7, 2023

Related U.S. Application Data
(60) Provisional application No. 63/430,905, filed on Dec. 7, 2022.

(51) Int. Cl. B63H 21/20

(52) U.S. Cl. CPC B63H 21/20; B63H 2021/205

(57) ABSTRACT

A system includes a marine vessel internal combustion engine. The system also includes a propeller that when in operation rotates. The system further includes an electric motor disposed between the marine vessel internal combustion engine and the propeller, wherein the electric motor when in a selected operating mode imparts rotation to the propeller.

### CROSS REFERENCE TO RELATED APPLICATIONS

This application is a Non-Provisional application claiming priority to U.S. Provisional Patent Application No. 63/430,905, entitled “Hybrid Propulsion System”, filed Dec. 7, 2022, which is herein incorporated by reference.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Hybrid technology is starting to become more and more accepted in as a method of reducing the fuel consumption and the emissions. For example, advances and technologies deployed in the automotive industry have allowed for an increase in the number of hybrid gas-electric automobiles in use. Hybrid automobiles allow for the reduction of fuel consumption and the emissions associated therewith. In contrast, propulsion systems for marine vessels typically continue to utilize traditional gas burning engines.

### BRIEF DESCRIPTION OF DRAWINGS

FIG. 1 illustrates a side view of a marine vessel, in accordance with an embodiment;

FIG. 2 illustrates a first cross-sectional side view of the rear portion of the marine vessel of FIG. 1 including a first embodiment of the propulsion device of FIG. 1, in accordance with an embodiment;

FIG. 3 illustrates a second cross-sectional side view of the rear portion of the marine vessel of FIG. 1 including a second embodiment of the propulsion device of FIG. 1, in accordance with an embodiment;

FIG. 4 illustrates a side view of the marine vessel of FIG. 1 having a third propulsion device, in accordance with an embodiment;

FIG. 5 illustrates a side view of the marine vessel of FIG. 1 having a fourth propulsion device, in accordance with an embodiment; and

FIG. 6 illustrates a block schematic describing a method of control of any of the propulsion systems of FIGS. 3 and 5, in accordance with an embodiment.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

There is a large opportunity for hybridization of propulsion systems for marine vessels, such as, stern drive, v-drive, outboard motors, and the like. New marine vessel propulsion systems can be implemented that utilize the described systems herein, such that the present hybrid-propulsion systems allow for both gas and electric propulsion and/or electric only propulsion. This can allow for increases in efficiency relative to existing gas only marine vessel propulsion systems.

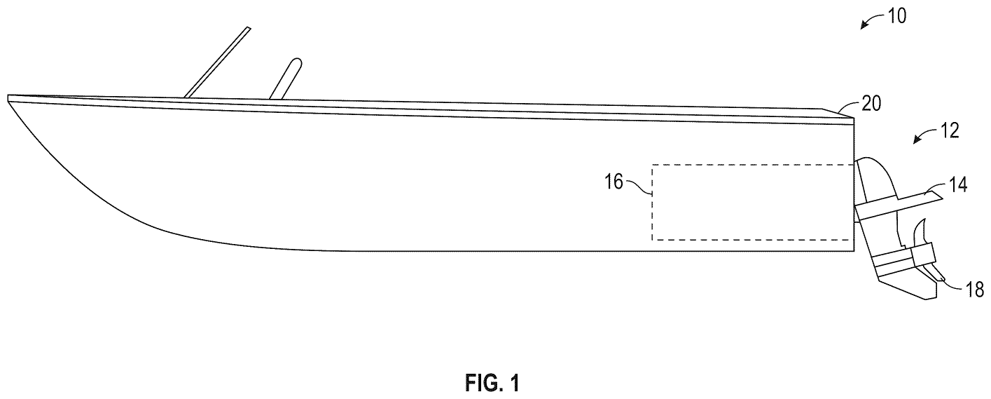

With the foregoing in mind, FIG. 1 illustrates side view of a marine vessel 10. The marine vessel 10 as illustrated includes a propulsion system 12. The propulsion system 12 as illustrated is a stern drive with an outboard drive 14 coupled to an inboard drive 16. In some embodiments, the outboard drive 14 operates to drive one or more propellers 18 as well as steer the marine vessel 10. The inboard drive 16 operates as a powering device that powers the outboard drive to provide propulsion to the marine vessel 10. As illustrated, the propulsion system 12 extends through a transom 20 of the marine vessel 10 with the inboard drive 16 internal to the marine vessel 10 and the outboard drive 14 external to the marine vessel 10. In some embodiments, the outboard drive 14 may be coupled directly to the inboard drive 16. Likewise, in some embodiments, the propulsion system 12 may instead be, for example, an outboard motor or other propulsion device.

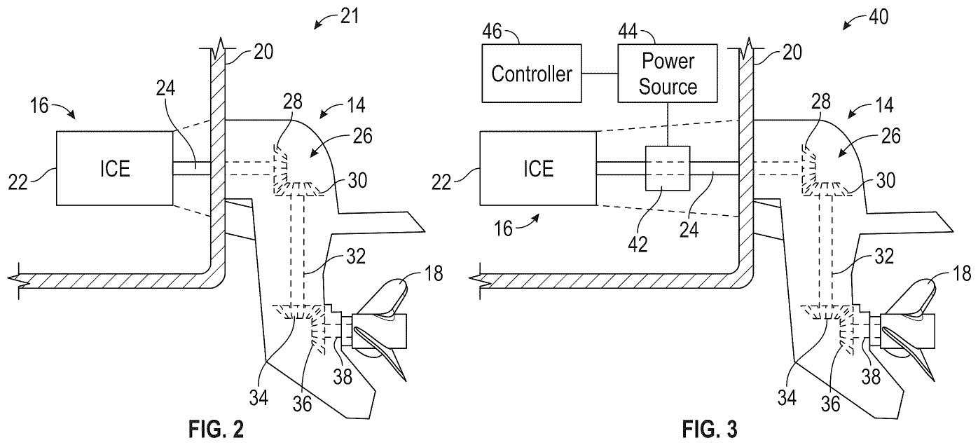

FIG. 2 illustrates a first cross-sectional side view of the rear portion of the marine vessel 10 including a gas propulsion system 21 as the propulsion system 12. As illustrated, the inboard drive 16 includes an internal combustion engine (ICE) 22. Additionally, the inboard drive 16 includes a drive shaft 24 coupled to the ICE 22. In operation, the ICE 22 operates to impart rotation to the drive shaft 24. As additionally illustrated, the drive shaft 24 continues from the inboard drive 16 to the outboard drive 14. The drive shaft 24 is coupled to a transmission 26. The transmission 26 can operate to transfer torque from the drive shaft 24 to rotate the one or more propellers 18. As illustrated, the transmission 26 can, for example, include gear 28, gear, 30, intermediate shaft 32, gear 34, and gear 36. Gear 28 is coupled to the drive shaft 24, such that rotation of the drive shaft 24 causes corresponding rotation to gear 28. Gear 28, by directly contacting gear 30, causes rotation of gear 30. Additionally, gear 30 is coupled to intermediate shaft 32, such that the rotation of gear 30 causes rotation of intermediate shaft 32.

Likewise, gear 34 is coupled to intermediate shaft 32, such that the rotation of the intermediate shaft 32 causes rotation of gear 34. Furthermore, gear 34 is coupled to gear 36 such that rotation of gear 34 causes rotation of gear 36. Gear 36 is coupled to propeller shaft 38, which is coupled to the one or more propellers 18. Rotation of gear 36 causes rotation of the propeller shaft 38 and, accordingly, the one or more propellers 18. The gear ratios of gear 28, gear 30, gear 34, and/or gear 36 may be set to predetermined values so that rotation speeds in the drive shaft 24 correspond to desired rotation speed of the one or more propellers. It should further be noted that the transmission 26 as described above is one example of a transmission that may be used to convert the rotation of the drive shaft 24 to rotation of the one or more propellers 18. However, other transmissions may replace transmission 26 and/or other techniques to impart the rotation of the drive shaft 24 to rotation of the one or more propellers 18 may be implemented.

In this manner, FIG. 2 illustrates the propulsion system 12 as a gas propulsion system 21. Alternatively, as illustrated in FIG. 3, propulsion system 12 may instead be a hybrid-propulsion system 40 that allows for both gas and electric propulsion and/or can allow for electric only propulsion. The hybrid-propulsion system 40 additionally includes an electric motor 42 in addition to the elements of the gas propulsion system 21 described above with respect to FIG. 2. It should be noted that the electric motor 42 can be a single electric motor 42 or, for example, a plurality of electric motors 42 (e.g., two or more motors in tandem). Furthermore, the electric motor 42 can include, for example, one stator and one or more rotors. As illustrated, the electric motor 42 can be directly coupled to (e.g., in contact with and/or disposed about) the drive shaft 24 to impart rotation to the drive shaft 24 when the electric motor 42 is in operation (e.g., when the electric motor 42 is in a first operational mode). Likewise, the electric motor 42 can be directly coupled to (e.g., in contact with and/or disposed about) the drive shaft 24, such that rotation of the drive shaft 24 drives the electric motor 42 in a second mode of operation (e.g., when the electric motor 42 is operating as a generator of electric power and/or electric charge).

As further illustrated in FIG. 3, a power source 44 may be coupled to the electric motor 42. The power source 44 may include one or more of, for example, one or more batteries, one or more fuel cells, one or more auxiliary power units (APUs), and/or similar sources of electric power. The one or more APUs may be electric generators that, for example, are disposed in one or more of the inboard drive 16, another location internal to the marine vessel 10, and/or the outboard drive 14. Furthermore, as noted above, when the electric motor 42 is operating in a particular mode (i.e., as a generator), the electric motor 42 may transmit the electric power and/or electric charge to the power source 44 to, for example, recharge the power source. Additionally, a controller 46 (e.g., control circuitry) may be included to control the amount of power transmitted to the electric motor 42 in conjunction with a particular operation of the hybrid-propulsion system 40. For example, during a starting operation, the controller 46 may operate to allow for an increased amount of power to be transmitted from the power source 44 to the electric motor 42 relative to a cruising operation when the marine vessel 10 is at a stable speed (i.e., the controller can determine various levels of power to be provided to the electric motor 42 that coincide with particular operations of the hybrid-propulsion system 40). Likewise, the controller 46 may control the amount of power transmitted from the electric motor 42 in conjunction with a particular operation of the hybrid-propulsion system 40 (i.e., when the electric motor 42 is operating as a generator to, for example, charge and/or recharge the power source 44). In some embodiments, the controller 46 may operate to selectively choose the operating mode of the electric motor 42 (i.e., as a motor imparting rotation to the drive shaft 24 or as a generator providing charge to the power source 44). These modes may be selectable, for example, by a user and/or in conjunction with a predetermined operation.

The controller 46 may be part of a larger computing system or control system or a standalone unit electric power controller. In some embodiments, the controller 46 may be communicatively coupled to a main control system, for example, a control system in a helm of the marine vessel 10 that may provide a centralized control system for one or more portions of the hybrid-propulsion system 40 (e.g., to allow a user to select between a gas only propulsion mode, a hybrid propulsion mode in which propulsion is provided by both the ICE 22 and the electric motor 42, and/or an electric mode in which in propulsion is provided by the electric motor 42. The controller 46 and/or any computing or control system associated therewith, may operate in conjunction with software systems implemented as computer executable instructions stored in a (tangible) non-transitory machine readable medium, such as memory, a hard disk drive, or other short term and/or long term storage. Particularly, the techniques to described below with respect to control of aspects of the power source and/or other components of the hybrid-propulsion system 40 may be accomplished, for example, using code or instructions stored in the non-transitory machine readable medium and may be executed, for example, by the controller 46 as well as by additional separate controllers controlling aspects of the operation of the hybrid-propulsion system 40 that are separate from the operation of the electric motor 42.

The controller 46 may be a general purpose or a special purpose processing device, such as one or more application specific integrated circuits (ASICs), one or more processors, or another processing device that interacts with one or more tangible, non-transitory machine-readable medium (e.g., machine readable media) that collectively stores instructions executable by the controller 46 to perform the methods and actions described herein. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by the controller 46. In some embodiment, the instructions executable by the controller 46 are instead generated and transmitted to the controller 46 via separate processing device of a computing system and are used to generate, for example, control signals or input signals to effect control of the power source and/or the electric motor 42.

Any computing system controlling the controller 46 or control system inclusive of the controller 46 may also include one or more input structures (e.g., one or more of a keypad, mouse, touchpad, touchscreen, one or more switches, buttons, or the like) to allow a user to interact with the computing system, for example, to start, control, or operate a graphical user interface (GUI) or applications running on the computing system and/or to start, control, or operate, for example, components utilized in a particular hybrid-propulsion system 40 operation (e.g., in a gas only propulsion mode, in a hybrid propulsion mode, and/or in an electric propulsion mode). Alternatively, the control system of computing system operating the controller 46 may instead automatically control the operation of the controller 46 based either on inputs from a user or measured inputs of the hybrid-propulsion system 40 that correspond to predetermined operations.

As illustrated in FIG. 3, the drive shaft 24 may be lengthened relative to the gas propulsion system 21 and the ICE 22 may be moved towards the bow of the marine vessel 10 to allow room for the electric motor 42 to be coupled to the drive shaft 24. For example, the portion of the drive shaft 24 in the inboard drive 16 may be, for example, approximately 12 inches, approximately 13 inches, approximately 14 inches, approximately 15 inches, approximately 16 inches, approximately 17 inches, approximately 18 inches, approximately 19 inches, approximately 20 inches, approximately 21 inches, approximately 22 inches, approximately 23 inches, approximately 24 inches, between approximately 12 inches and approximately 24 inches, or another value. However, it should be noted that other locations of connection of the electric motor 42 to the drive shaft 24 may be implemented. For example, the electric motor 42 may instead be directly coupled to (e.g., in contact with and/or disposed about) the drive shaft 24 in the outboard drive 14. Likewise, the electric motor 42 may be directly coupled to (e.g., in contact with and/or disposed about) the intermediate shaft 32 to impart rotation to the intermediate shaft 32 when the electric motor 42 is in operation. Similarly, the electric motor 42 may be directly coupled to (e.g., in contact with and/or disposed about) the propeller shaft 38 to impart rotation to the propeller shaft 38 when the electric motor 42 is in operation.

In other embodiments, more than one electric motor 42 may be utilized. For example, an electric motor 42 may be directly coupled to (e.g., in contact with and/or disposed about) the drive shaft 24 in the inboard drive 16, an electric motor 42 may be directly coupled to (e.g., in contact with and/or disposed about) the drive shaft 24 in the outboard drive 14, an electric motor 42 may be directly coupled to (e.g., in contact with and/or disposed about) the intermediate shaft 32 in the outboard drive 14, and/or an electric motor 42 may be directly coupled to (e.g., in contact with and/or disposed about) the propeller shaft 38. It is envisioned that any combination of these locations of electric motors 42 can be utilized (e.g., an electric motor 42 coupled to the drive shaft 24 in the inboard drive 16, an electric motor 42 coupled to the drive shaft 24 in the outboard drive 14, an electric motor 42 coupled to the intermediate shaft 32 in the outboard drive 14, and an electric motor 42 coupled to the propeller shaft 38, and/or any combination of an electric motor 42 in one, two, and/or three of the aforementioned locations). Similarly, each electric motor 42 may be coupled to the same power source 44, may each be individually coupled to a unique power source 44, or more than one electric motor 42 can each be coupled to a common power source 44. Similarly, each electric motor 42 may be controlled by a single controller 46, may each be individually controlled by a unique controller 46, or more than one electric motor 42 can each be coupled to a common controller 46. This may provide additional flexibility in implementing the hybrid-propulsion system 40.

Regardless of whether one or more than one electric motor 42 is utilized, in operation, the utilized electric motors 42 may operate in a charging mode to charge the respective power sources 44 in which the electric motors 42 generate power from the rotation of the respective shaft that the electric motor 42 is coupled to and transmit that generated power to the respective power source 44 coupled thereto. Likewise, the utilized electric motors 42 may operate in an electric mode in which the electric motor(s) 42 draw charge from the respective power sources 44 coupled thereto to provide rotation to the respective shaft coupled to the respective electric motor 42 without any additional rotation imparted by the ICE 22. Furthermore, the utilized electric motors 42 may operate in a hybrid mode in which the electric motor(s) 42 draw charge from the respective power sources 44 coupled thereto to provide rotation to the respective shaft coupled to the respective electric motor 42 in conjunction to additional rotation imparted by the ICE 22. Finally, in an additional mode, the utilized electric motors 42 may operate in a standby mode whereby the electric motor(s) 42 are disconnected (e.g., via a switch or other mechanism to interrupt the circuit with the respective power source 44). These various modes may provide additional flexibility in operating the hybrid-propulsion system 40.

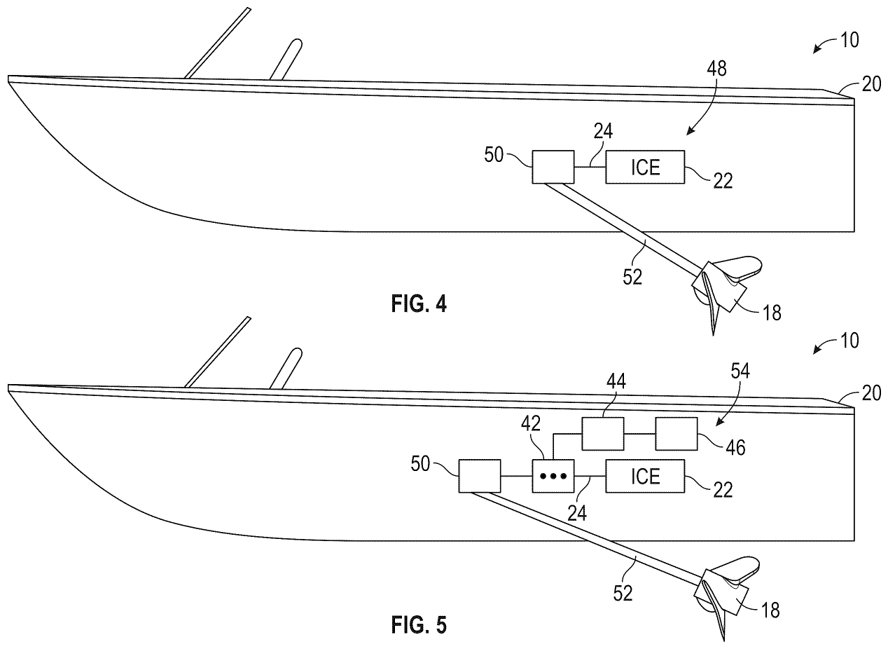

FIG. 4 illustrates a side view of the marine vessel 10 having a gas propulsion system 48 in place of the propulsion system 12 of FIG. 1. As illustrated, the gas propulsion system 48 is a v-drive system that includes the ICE 22 disposed generally in the stern of the marine vessel 10. Additionally, the gas propulsion system 48 includes a drive shaft 24 coupled to the ICE 22. In operation, the ICE 22 operates to impart rotation to the drive shaft 24. As additionally illustrated, the drive shaft 24 is coupled to a transmission 50. It should be noted that the transmission 50 may be similar to the transmission 26 described above (e.g., inclusive of an intermediate shaft 32). In other embodiments, the transmission 50 may operate to directly couple (e.g., via gears) the drive shaft 24 to a propeller shaft 52 coupled to the one or more propellers 18 (in a manner similar to propeller shaft 38 discussed above). Regardless of the configuration employed, the transmission 50 may operate to convert the rotation of the drive shaft 24 to rotation of the one or more propellers 18. Accordingly, the transmission 50 can operate to transfer torque from the drive shaft 24 to rotate the one or more propellers 18.

In this manner, FIG. 4 illustrates a gas propulsion system 48. Alternatively, as illustrated in FIG. 5, a hybrid-propulsion system 54 may instead be utilized that allows for both gas and electric propulsion and/or can allow for electric only propulsion. As illustrated, the hybrid-propulsion system 54 is a v-drive system similar to the gas propulsion system 48, but additionally includes an electric motor 42, a power source 44, and a controller 46, as described above in conjunction with FIG. 3. It should be noted that as described above, in some embodiments, the electric motor 42 can operate in a selected mode of operation in which the electric motor imparts rotation to the drive shaft 24 as well as a second selected mode of operation in which rotation of the drive shaft 24 drives the electric motor 42 (e.g., when the electric motor 42 is operating as a generator of electric power and/or electric charge to charge and/or recharge the power source 44).

As illustrated in FIG. 5, the drive shaft 24 may be lengthened relative to the a gas propulsion system 48 and the ICE 22 may be moved towards the stern of the marine vessel 10 to allow room for the electric motor 42 to be directly coupled to (e.g., in contact with and/or disposed about) the drive shaft 24. However, it should be noted that other locations of connection of the electric motor 42 to the drive shaft 24 may be implemented. For example, the electric motor 42 may instead be directly coupled to (e.g., in contact with and/or disposed about) the drive shaft 24 in the transmission 50 (or any intermediate shaft therein connecting the drive shaft 24 to the propeller shaft 52). Likewise, the electric motor 42 may be directly coupled to (e.g., in contact with and/or disposed about) the propeller shaft 52 to impart rotation to the propeller shaft 52 when the electric motor 42 is in operation.

In other embodiments, more than one electric motor 42 may be utilized. For example, an electric motor 42 may be directly coupled to (e.g., in contact with and/or disposed about) the drive shaft 24 between the ICE 22 and the transmission 50, an electric motor 42 may be directly coupled to (e.g., in contact with and/or disposed about) the drive shaft 24 in transmission 50 (and/or any intermediate shaft therein connecting the drive shaft 24 to the propeller shaft 52), and/or an electric motor 42 may be directly coupled to (e.g., in contact with and/or disposed about) the propeller shaft 52. It is envisioned that any combination of these locations of electric motors 42 can be utilized. Similarly, each electric motor 42 may be coupled to the same power source 44, may each be individually coupled to a unique power source 44, or more than one electric motor 42 can each be coupled to a common power source 44. Similarly, each electric motor 42 may be controlled by a single controller 46, may each be individually controlled by a unique controller 46, or more than one electric motor 42 can each be coupled to a common controller 46. This may provide additional flexibility in implementing the hybrid-propulsion system 54.

Regardless of whether one or more than one electric motor 42 is utilized, in operation, the utilized electric motors 42 may operate in a charging mode to charge the respective power sources 44 in which the electric motors 42 generate power from the rotation of the respective shaft that the electric motor 42 is coupled to and transmit that generated power to the respective power source 44 coupled thereto. Likewise, the utilized electric motors 42 may operate in an electric mode in which the electric motor(s) 42 draw charge from the respective power sources 44 coupled thereto to provide rotation to the respective shaft coupled to the respective electric motor 42 without any additional rotation imparted by the ICE 22. Furthermore, the utilized electric motors 42 may operate in a hybrid mode in which the electric motor(s) 42 draw charge from the respective power sources 44 coupled thereto to provide rotation to the respective shaft coupled to the respective electric motor 42 in conjunction to additional rotation imparted by the ICE 22. Finally, in an additional mode, the utilized electric motors 42 may operate in a standby mode whereby the electric motor(s) 42 are disconnected (e.g., via a switch or other mechanism to interrupt the circuit with the respective power source 44). These various modes may provide additional flexibility in operating the hybrid-propulsion system 54.

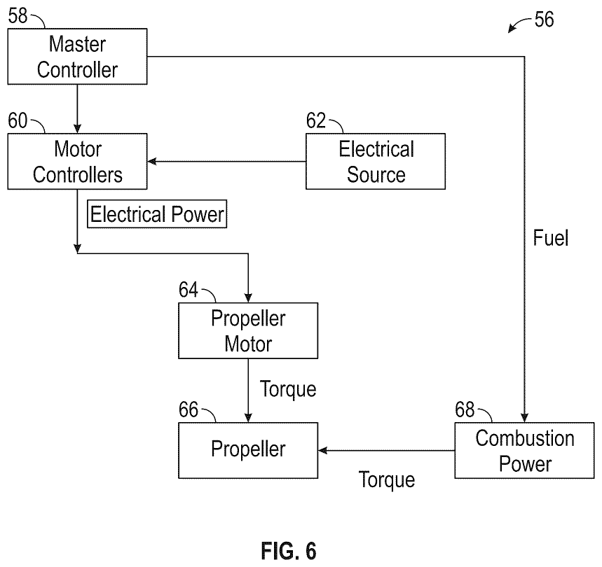

Turning to FIG. 6, a block schematic 56 is illustrated. The block schematic 56 may represent a control system that is used in conjunction with the hybrid-propulsion system 40 and/or the hybrid-propulsion system 54. However, particular branches of the block schematic 56 also represent control operations for the gas propulsion systems 21 and 48. Furthermore, while the block schematic 56 generally represents the use of a single controller 46, it should be noted that the single controller 46 can control respective power sources 44 or a single power source 44 and/or separate controllers 46 can implement the blocks of the block schematic 56.

In block 58, the controller 46 receives, for example, readings from the combustion process (e.g., temperature) of the ICE 22, and/or readings from the drive shaft 24 (e.g., shaft torque). These readings may be recorded and/or transmitted from sensors disposed in the hybrid-propulsion system 40 and/or the hybrid-propulsion system 54 at locations proximate to the reading locations with operational parameters to be measured. In block 58, the controller 46 processes the input data and in block 60, the controller 46 transmits commands, for example, to control fuel injectors for combustion in the ICE 22 and/or to motor controllers for the electric motors 42 to govern their RPMs.

The controller 46 may, as illustrated in block 62, control an amount of power transmitted from the power source(s) 44 to the electric motor(s) 42. The electric motor 42 powering, for example, the drive shaft 24, provides, in block 64, a portion of the total necessary shaft work needed by the hybrid-propulsion system 40 and/or the hybrid-propulsion system 54 in block 66. The remainder of the power required for a particular operation is provided by combustion power in block 68, as also controlled by the controller 46 through, for example, an amount of fuel mixed with the compressed air and combusted thereafter in the ICE 22.

It should also be noted that in some embodiments, retrofit the marine vessel 10 having the gas propulsion system 21 and/or the gas propulsion system 48 may be accomplished to provide hybrid capability. This may include, for example, removal of the drive shaft 24 from the gas propulsion system 21 and/or the gas propulsion system 48 and replacement thereof with a longer drive shaft 24 (i.e., the drive shaft 24 of FIGS. 3 and 5) as well as addition of an electric motor 42 disposed thereabout. The retrofit may additionally include addition of the power source 44 and the controller 64. In some embodiments, the retrofit may additionally include movement of the ICE 22 towards the bow of the marine vessel 10 (in conjunction with the marine vessel 10 of FIG. 2) or towards the stern of the marine vessel 10 (in conjunction with the marine vessel 10 of FIG. 4). The electric motor 42 may be provided with the replacement drive shaft 24 (e.g., already coupled to and disposed about the replacement drive shaft 24) or may be coupled to the replacement drive shaft 24 prior to installing the replacement drive shaft 24 into the respective marine vessel.

This written description uses examples to disclose the above description to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Accordingly, while the above disclosed embodiments may be susceptible to various modifications and alternative forms, specific embodiments have been shown by way of example in the drawings and have been described in detail herein. However, it should be understood that the embodiments are not intended to be limited to the particular forms disclosed. Rather, the disclosed embodiment are to cover all modifications, equivalents, and alternatives falling within the spirit and scope of the embodiments as defined by the following appended claims.

What is claimed is:

1. A system, comprising:
a marine vessel internal combustion engine;
a propeller that when in operation rotates; and
an electric motor disposed between the marine vessel internal combustion engine and the propeller, wherein the electric motor when in a selected operating mode imparts rotation to the propeller.

2. The system of claim 1, comprising a drive shaft coupling the internal combustion engine to the propeller.

3. The system of claim 2, wherein the electric motor is directly coupled to the drive shaft.

4. The system of claim 3, wherein the electric motor when in the selected operating mode imparts rotation to the propeller by imparting rotation to the drive shaft.

5. The system of claim 4, wherein the electric motor when in a second selected operating mode is driven by rotation of the drive shaft.

6. The system of claim 5, comprising a controller coupled to the electric motor.

7. The system of claim 6, wherein the controller when in operation controls an operation mode of the electric motor to place the electric motor in the selected operation mode.

8. The system of claim 7, wherein the controller when in operation controls the operation mode of the electric motor to place the electric motor in the second selected operation mode.

9. The system of claim 8, comprising a power source coupled to the controller and the electric motor.

10. The system of claim 9, wherein the wherein the controller when in operation controls an amount of power transmitted from the power source to the electric motor.

11. A method, comprising installing an electric motor between an internal combustion engine of a marine vessel and the propeller of the marine vessel, wherein the electric motor when in a selected operating mode imparts rotation to the propeller.

12. The method of claim 11, comprising moving the internal combustion engine towards a bow of the marine vessel.

13. The method of claim 12, comprising removing a first drive shaft from the marine vessel; and installing a second drive shaft between the internal combustion engine and the propeller, wherein the second drive shaft has a second length greater than a first length of the first drive shaft.

14. The method of claim 13, comprising coupling the electric motor to the drive shaft.

15. The method of claim 14, comprising coupling a power source to the electric motor.

16. The method of claim 15, comprising coupling a controller to the electric motor and to the power source.

17. An apparatus, comprising:
a drive shaft configured to be coupled to a marine vessel internal combustion engine; and
an electric motor disposed about the drive shaft, wherein the electric motor when in a selected operating mode imparts rotation to the drive shaft.

18. The apparatus of claim 17, wherein the electric motor when in a second selected operating mode is driven by rotation of the drive shaft.

19. The apparatus of claim 18, comprising a power source configured to be coupled to the electric motor.

20. The apparatus of claim 19, comprising a controller configured to be coupled to the power source and the electric motor, wherein the controller is configured to control an amount of power transmitted from the power source to electric motor when the electric motor is in the selected operating mode.
